(19) United States
(12) Patent Application Publication
(10) Pub. No.: US 2018/0348533 A1
(43) Pub. Date: Dec. 6, 2018

(54) DISPLAY SYSTEM AND DISPLAY METHOD OF DISPLAY SYSTEM

(71) Applicant: BOE TECHNOLOGY GROUP CO., LTD., Beijing (CN)

(72) Inventor: Wenbo LI, Beijing (CN)

(73) Assignee: BOE TECHNOLOGY GROUP CO., LTD., Beijing (CN)

(21) Appl. No.: 15/755,821

(22) PCT Filed: Jul. 4, 2017
(86) PCT No.: PCT/CN2017/091601

§ 371 Date: Feb. 27, 2018

(30) Foreign Application Priority Data
Jan. 23, 2017 (CN) 201710058457.1

(51) Int. Cl. G02B 27/22; G03H 1/00; G03H 1/02

(52) U.S. Cl. CPC G02B 27/225; G02B 27/2235; G02B 27/2278; G03H 1/22; G03H 1/0252; G03H 2250/42; G03H 1/0005

(57) ABSTRACT

A display system and a display method of the display system are provided, and the display system includes: at least one holographic image display device, each holographic image display device is configured to display a holographic image of a scene; at least one reflection image display device, each reflection image display device is configured to display a reflection image of a scene; the at least one holographic image display device and the at least one reflection image display device are arranged in parallel, and the holographic image and the reflection image are displayed to achieve a stereoscopic display in a display side of the display system.

The present application claims the priority of the Chinese Patent Application No. 201710058457.1 filed on Jan. 23, 2017, the entirety of which is incorporated herein by reference as a part of the present application.

### TECHNICAL FIELD

Embodiments of the present disclosure relate to a display system and a display method of the display system.

### BACKGROUND

With the development of science and technology and the improvement of people's living standards, people's requirements for a display system are not only limited to transfer a 2D (two-dimensional) planar information simply, but also to provide a 3D (three-dimensional) image information more realistic, with a three-dimensional experience and closer to the actual experience of the human's eye.

At present, the common three-dimensional display device generally adopts a principle of parallax type three-dimensional display, the left views and right views are separated by lens or gratings, the left views and the right views enter an observer's left eye and right eye respectively, then a stereoscopic perception is achieved by binocular visual mixture.

### SUMMARY

At least one embodiment of the present disclosure provides a display system, and the display system includes: at least one holographic image display device, each holographic image display device is configured to display a holographic image of a scene; at least one reflection image display device, each reflection image display device is configured to display a reflection image of a scene; and the at least one holographic image display device and the at least one reflection image display device are arranged in parallel, and the holographic image and the reflection image are displayed to achieve a stereoscopic display in a display side of the display system.

For example, in the display system provided by at least one embodiment of the present disclosure, the stereoscopic display is a multi-layer stereoscopic display.

For example, in the display system provided by at least one embodiment of the present disclosure, the holographic image display device and the reflection image display device are arranged side by side in a horizontal direction or arranged side by side in a vertical direction.

For example, in the display system provided by at least one embodiment of the present disclosure, the holographic image display device includes a holographic film and a first projector.

For example, in the display system provided by at least one embodiment of the present disclosure, the holographic film includes a mirror layer, a first filter layer, a matrix layer, a second filter layer and a bead layer which are stacked in sequence.

For example, in the display system provided by at least one embodiment of the present disclosure, the first filter layer is a carbon black layer, and the second filter layer is a transparent filter layer.

For example, in the display system provided by at least one embodiment of the present disclosure, the reflection image display device includes a reflective component and a display component.

For example, in the display system provided by at least one embodiment of the present disclosure, the display component is a second projector.

For example, in the display system provided by at least one embodiment of the present disclosure, the reflective component includes a transflective component or a total reflective component.

For example, in the display system provided by at least one embodiment of the present disclosure, the transflective component includes a substrate and a coating applied to a main surface of the substrate.

For example, in the display system provided by at least one embodiment of the present disclosure, the main surface of the substrate is entirely or partially coated with the coating.

For example, in the display system provided by at least one embodiment of the present disclosure, the coating is made of polyethylene terephthalate or an opaque metal material.

For example, in the display system provided by at least one embodiment of the present disclosure, the transflective component is provided with light-transmitting holes arranged at intervals or light-transmitting slits arranged at intervals.

At least one embodiment of the present disclosure further provides a display method of the display system, and the display method includes: the holographic image display device displays a holographic image and the reflection image display device displays a reflection image to achieve a stereoscopic display.

For example, the display method provided by at least one embodiment of the present disclosure further includes: the holographic image and the reflection image display a content of a same scene; or the holographic image and the reflection image display contents of supplementary scenes.

For example, the display method provided by at least one embodiment of the present disclosure further includes: the holographic image is displayed as a foreground or a background of the reflection image; or the reflection image is displayed as a foreground or a background of the holographic image.

### BRIEF DESCRIPTION OF THE DRAWINGS

In order to clearly illustrate the technical solution of the embodiments of the present disclosure, the drawings of the embodiments will be briefly described in the following, it is obvious that the described drawings are only related to some embodiments of the present disclosure and thus are not limitative of the present disclosure.

FIG. 1 is a schematic view of a three-dimensional display;

FIG. 2 is a schematic structural view of a display system provided by an embodiment of the present disclosure;

FIG. 3 is a schematic structural view of a holographic film provided by an embodiment of the present disclosure; and

FIG. 4 is a display effect schematic view of the display system shown in FIG. 2 in a case that an observer's position is changed.

### DETAILED DESCRIPTION

In order to make objects, technical details and advantages of the embodiments of the invention apparent, the technical solutions of the embodiment will be described in a clearly and fully understandable way in connection with the drawings related to the embodiments of the disclosure. It is obvious that the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the words, such as “comprise/comprising”, “include/including”, etc., mean the components or objects that appear in front of the words to cover the similar components or objects that are listed in the following of the words, but other different components or objects are not excluded. The phrases “connect”, “connected”, etc., are not limited to a physical connection or mechanical connection, but may include an electrical connection, directly or indirectly. The terms “up”, “down”, “left”, “right”, etc., are used to indicate the relative position relation, when the absolute position of the described object is changed, the relative position relation may also be changed accordingly.

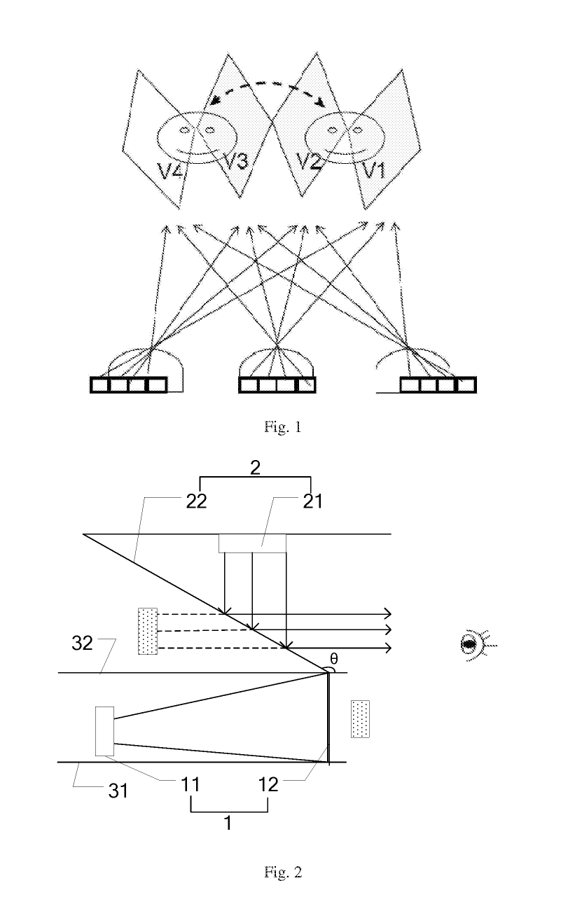

FIG. 1 is a schematic view of a three-dimensional display, as illustrated in FIG. 1, the three-dimensional display only provides a limited viewpoint information, so that the three-dimensional viewable region is limited. The observer can only see three-dimensional images in the regions of V1, V2, V3 and V4 in FIG. 1. Therefore, the three-dimensional display only provides separate viewable regions and limited viewpoints, in this way, a headache, nausea and other reactions may be caused for the an observer in a case of viewing for a long time. In a case that an observer observes from a main surface of the display device, the display effect is relatively poor. In addition, the three-dimensional display images presented in above manner will not change as the eyes of the observer move, and the images of different viewing angles cannot be displayed correspondingly. Therefore, it is impossible to provide an immersive 3D display effect for the observer, and the displayed image is not intuitive.

At least one embodiment of the present disclosure provides a display system, and the display system includes: at least one holographic image display device, each holographic image display device is configured to display a holographic image of a scene; at least one reflection image display device, each reflection image display device is configured to display a reflection image of a scene; the at least one holographic image display device and the at least one reflection image display device are arranged in parallel, and the holographic image and the reflection image are displayed to achieve a stereoscopic display in a display side of the display system. The stereoscopic display image can be observed by a plurality of people at a same time and observed by naked-eyes, and further can be observed at multiple angles without the help of any visual equipments, and gives a real stereoscopic experience for the observers, which can also achieve a large-size, a high-resolution, a high-contrast dynamic image for suspension display.

At least one embodiment of the present disclosure provides a display system, FIG. 2 is a schematic structural view of a display system provided by an embodiment of the present disclosure, as illustrated in FIG. 2, the display system includes: at least one holographic image display device 1 and at least one reflection image display device 2. Each holographic image display device 1 is configured to display a holographic image of a scene; each reflection image display device 2 is configured to display a reflection image of a scene; the at least one holographic image display device 1 and the at least one reflection image display device 2 are arranged in parallel, and the holographic image and the reflection image are displayed to achieve a stereoscopic display in a display side of the display system.

The stereoscopic display image can be observed by a plurality of people at a same time and observed by naked-eyes, and further can be observed at multiple angles without any visual equipments, and gives a real stereoscopic experience for the observers, and a large-size, a high-resolution, a high-contrast dynamic image for suspension display can also be achieved.

For example, the stereoscopic display is a multi-layer stereoscopic display.

For example, the holographic image display device 1 and the reflection image display device 2 are arranged side by side in a horizontal direction or arranged side by side in a vertical direction. For example, in FIG. 2, the holographic image display device 1 and the reflection image display device 2 are arranged side by side in a vertical direction. For example, the holographic image display device 1 is located on a first plane and the reflection image display device 2 is located on a second plane, and a height of the second plane is higher than a height of the first plane, that is, the reflection image display device 2 is located above the holographic image display device 1. The first plane and the second plane, for example, correspond to the first plate and the second plate, or correspond to the first platform and the second platform. Thus, the display system is suitable for various scenes in size, for example, a desktop display system or a stage display system and the like.

For example, in FIG. 2, the holographic image display device 1 and the reflection image display device 2 may be also considered as arranged side by side in a horizontal direction. The reflection image display device 2 is located on a same plane as the holographic image display device 1, and the reflection image display device 2 is located on the right side of the holographic image display device 1. In this way, the holographic image displayed by the holographic image display device 1 and the reflection image displayed by the reflection image display device 2 can be combined.

For example, the holographic image display device 1 includes a holographic film 12 and a first projector 11. The holographic film 12 has a transparent property that allows the observer to see the scene behind the holographic film while maintaining a clear image, in addition, the quality of the picture is clear and bright without space limitations, which achieves that regardless of whether the light source is sufficient, the observer can observe the images directly in front or back of the holographic film 12 and multi-angle view the images.

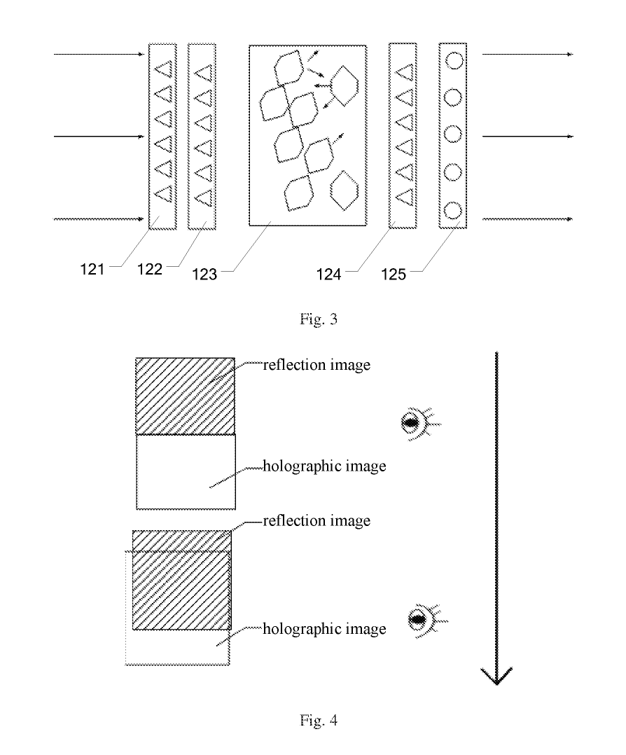

For example, FIG. 3 is a schematic structural view of a holographic film provided by an embodiment of the present disclosure. As illustrated in FIG. 3, the holographic film 12 includes a mirror layer 121, a first filter layer 122, a matrix layer 123, a second filter layer 124 and a bead layer 125 which are stacked in sequence.

For example, the first filter layer 122 is a carbon black layer, and the second filter layer 124 is a transparent filter layer.

For example, after the first projector 11 projects an image on the holographic film 12 by a direct projection method or a rear projection method, and after the light passes through the mirror layer 121, the first filter layer 122, the matrix layer 123, the second filter layer 124 and the bead layer 125, for example a pre-suspension image is presented. In this process, the useless light (for example, divergent light and ambient light) is filtered out by the physical optical properties of each film. For example, the display side of the display system is a first surface, and the side opposite to the display side of the display system is a second surface. The mirror layer 121 allows the light of the second surface to pass successfully while the light of the first surface is totally reflected by the mirror layer 121. The first filter layer 122 (for example, the carbon black layer) is configured for scattering the projection light passing through the mirror layer 121 onto the first surface, and prevents the natural stray light of the first surface and the second surface from interfering with the projection light, so as to avoid of affecting the projection light scattered onto the first surface, and improve the contrast of the dynamic image suspension. The matrix layer 123 is an optical film formed of nanoscale crystalline material, for example, the optical film is formed of holographic color filter crystal (HCFC) nanoscale material. After the incident light enters the matrix layer 123, the incident light is refracted and reflected multiple times in the matrix layer 123, which may reduce the color loss and capable of capturing light and displaying images. The second filter layer 124 (for example, a transparent filter layer) is colorless and transparent, so that the incident light passes through the second filter layer 124 and the ambient light of the first surface and the second surface is reflected, the incident light and the ambient light of the first surface are complementarily interfered in the second filter layer 124 (for example, the transparent filter layer) to achieve the transparency of the screen. The bead layer 125 can enhance the diffuse reflection of the incident light and enhance the brightness of the output light. After the light projected from the first projector passes through the above film structures of the holographic film layer respectively, an image with a suspended visual effect is formed in the imaging region.

For example, the working principle of the holographic image display device 1 is as follows: an initial image data is stored in a memory, the initial image data can also be updated by an external interface. The external interface may be connected to a storage medium such as a computer. An image processing circuit unit extracts the data from the memory and processes into a dynamic image digital signal capable of forming a suspended parallax, then the digital signals are output to the holographic display device; the display driving circuit in the holographic display device converts the digital signals into dynamic images and then the dynamic images are projected on the holographic film 12 by the first projector 11 to display images.

For example, a plurality of holographic images may be displayed by the plurality of holographic image display devices 1, the plurality of holographic images can enrich the display content and enhance the three-dimensional experience of multi-layer suspension display; or, for example, real robots may be placed at a side of the holographic image display device close to the viewer to perform, so that the real robots and the holographic image display may be combined to further enhance the reality experience and stereoscopic effect.

For example, as illustrated in FIG. 2, the reflection image display device includes a reflective component 22 and a display component 21. The reflection image display device may form a rear-suspension virtual image.

For example, the display component 21 is a second projector, or the display component 21 may be another device having a similar function to the projector or a non-projection display device, which is not limited herein.

For example, the reflective component 22 includes a transflective component or a total reflective component. The transflective component controls the light better. The following embodiments take the transflective component as the reflective component 22 for example.

For example, in a case that the reflective component 22 is a transflective component, the transflective component includes a substrate and a coating applied to a main surface of the substrate. It should be noted that, the “transflective” refers to partial reflection, for example, the reflectivity ranges from 25% to 75%. Transflective component allows light to pass through at the same time of reflecting light.

For example, the main surface of the substrate is entirely or partially coated with the coating. In a case that the main surface of the substrate is entirely coated with a coating, the coating is a material having a transflective function; in a case that the main surface of the substrate is partially coated with a coating, the coating may be a material having a transflective function or a material having a total reflection function. It should be noted that, the transflective component may also be a substrate formed of a transflective material, which eliminates the requirements to form a coating on one main surface of the substrate, but this substrate has a problem of high cost, in general, the transflective component is formed by applying a coating on one main surface of the substrate.

For example, the coating is made of polyethylene terephthalate or an opaque metal material. It should be noted that, the material of the coating is not limited to the above materials, but may be other suitable materials.

For example, the coating further includes scattering particles. In order to improve the ability to reflect light of the coating, scattering particles may also be added to the coating. For example, the scattering particles include nanoparticles such as titania, silica and the like.

For example, the transflective component is provided with light-transmitting holes arranged at intervals or light-transmitting slits arranged at intervals, so that a portion of the light is transmitted through the light-transmitting holes or light-transmitting slits. For example, the light-transmitting holes or the light-transmitting slits may be formed of a discontinuous coating, or may be the holes or the slits provided on the substrate.

For example, the reflectivity of the coating is greater than zero. After the light emitted from the display component 21 reaches the coating of the transflective component, a portion of the light is transmitted through the coating and a portion of the light is reflected by the coating.

For example, the substrate is a transparent inorganic glass plate, an organic glass plate, a polyvinyl chloride (PVC) plate or a polycarbonate plate. The inorganic glass is made of silica; the organic glass plate is made of polymethyl methacrylate (PMMA); the PVC plate is made of polyvinyl chloride. A thickness of the transparent substrate is, for example, 0.1 mm to 3 mm, for example, approximately 0.1 mm, 0.5 mm, 2 mm or 3 mm. In general, the larger the display region, the greater the thickness of the substrate. In a case of using a PVC plate (also referred to as a PVC film) to form a transparent substrate, for example, its thickness is less than 0.26 mm. In a case that the PVC plate constitutes a transparent substrate, a hard border can be arranged at the perimeter of the transparent substrate to make it better to keep it flat.

For example, as illustrated in FIG. 2, the working principle of the reflection image display device is as follows: the light emitted by the display component 21 is incident on the reflective component 22. The reflective surface of the reflective component 22 forms a first angle θ with the horizontal plane, the size of the first angle θ is 105° to 150°, for example, approximately 105°, 120°, 140° or 150°. The image on the display component 21 is reflected forward by the reflection element 22 and received by the observer, an image with suspension parallax is observed, the image may be a dynamic image or a static image.

For example, the display process of the reflection image display device is as follows: a processing circuit receives a video signal (for example, a stereoscopic video signal) transmitted from an external device and converts the video signal into an electrical signal for driving an optical engine, the optical engine converts the electrical signal into an optical signal and projects it onto a projection optical system (for example a second projector), and the projection optical system projects the optical signal onto the transflective component. The light is reflected by the transflective component to form a virtual image that is suspended in a side of the transflective component.

For example, taking the holographic image display device 1 and the reflection image display device 2 arranged side by side in a vertical direction for example, the holographic image display device 1 is located on a first plane 31 and the reflection image display device 2 is located on a second plane 32, and a height of the second plane 32 is higher than a height of the first plane 31, that is, the reflection image display device 2 is located above the holographic image display device 1. For example, the height of the holographic film 12 is the height difference between the first plane 31 and the second plane 32, alternatively, the height of the holographic film 12 is greater than the height difference between the first plane 31 and the second plane 32.

In an example, the display principle that the holographic image display device combined with the reflection image display device is: the light projected by the first projector passes through the holographic film to form a holographic image (a front suspension display), and the light projected by the second projector forms a reflection image (a rear-suspension image) after passing through the reflective component (for example, a transflective component), the holographic image and the reflection image are spatially staggered and displayed at a same time, in this way, the effect of multi-layer stereoscopic display is realized. The multi-layer suspension holographic image and the reflection image observed by the audience have a multi-layer stereoscopic effect.

For example, the holographic image and the reflection image display a content of a same scene; or the holographic image and the reflection image display contents of supplementary scenes.

For example, the holographic image and the reflection image display a same content, in a case of observing in a certain region, the holographic image is partially overlapped with the reflection image that display a same content, so that the naked-eye three-dimensional images observed by the observers are more clearly and vividly.

For example, the holographic image is a dynamic suspension image, the reflection image is also a dynamic suspension image, and the holographic image and the reflection image display contents of supplementary scenes. For another example, the holographic image provided by the holographic image display device includes a holographic image of a basketball or the like that moves up and down, accordingly, the reflective image provided by the reflection image display device includes a robot, and the robot's hand moving up and down. Taking the observation from the side where the holographic image display device is located for an example, the naked-eye three-dimensional image finally provided for the observer is a combination of the reflection image and the holographic image, and the combined image gives the observers the feeling that the robot beats the basketball by hand and moves the basketball up and down. The naked-eye three-dimensional image formed under this condition gives the observer a more three-dimensional visual experience.

For example, the display contents of the holographic image display device and the reflection image display device may be controlled independently, in this way, the display contents displayed by the holographic image display device and the reflection image display device can be freely adjusted respectively to form a display image conforming to the observer's requirements. For example, in a case that the images that a person performs under different weather conditions are displayed, the images under different weather conditions are displayed by the reflection image display device, the contents that a person performs is displayed by the holographic image display device. By controlling the holographic image display device and the reflection image display device separately, different weather conditions and different performance contents can be selected.

For example, the holographic image is displayed as a foreground or a background of the reflection image; or the reflection image is displayed as a foreground or a background of the holographic image. For example, the holographic image is displayed as a three-dimensional image, the reflection image is displayed as a two-dimensional image, and the reflection image is displayed as a background of the holographic image.

For example, in the display system provided by the embodiments of the present disclosure, in one example, at least one of the holographic image display device and the reflection image display device is provided with an image capturing device. More specifically, for example, the image capturing device includes a human eye tracking unit.

In an example, FIG. 4 is a display effect schematic view of the display system shown in FIG. 2 in a case that an observer's position is changed. With reference to FIG. 4, in a case that the observer's eyes view the center of the display system, the holographic image is suspended above the reflection image, the reflection image of suspension display can be viewed as the background of the holographic image of suspension display; in a case that the observer's eyes move in the column direction (in a direction of the arrow in the figure) and deviate from the center of the display system, at this time, the relative position between the holographic image and the reflection image is changed, and the reflection image suspended behind the holographic image can be seen, and at this time, the suspended reflection image can also be regarded as the background of the suspended holographic image. Conversely, in a case that the observer's eyes move in the opposite direction as shown by the arrows in FIG. 4, the relative position between the holographic image and the reflection image is also changed. Therefore, the display system provided by the embodiments of the present disclosure can present a relatively real suspension display image, and with the observer's eyes moving, the images of the different perspective are presented, which is more suitable for the real viewing conditions, so that the audience has an immersive feeling.

At least one embodiment of the present disclosure further provides a display method of any above-mentioned display system, and the display method includes: the holographic image display device displays a holographic image and the reflection image display device displays a reflection image to achieve a stereoscopic display.

For example, the display method further includes: the holographic image and the reflection image display a content of a same scene; or the holographic image and the reflection image display contents of supplementary scenes.

For example, the holographic image and the reflection image display a same content, in a case that a certain region is observed, the holographic image is partially overlapped with the reflection image that display a same content, so that the naked-eye three-dimensional images observed by the observers are more clearly and vividly.

For example, the holographic image is a dynamic suspension image, the reflection image is also a dynamic suspension image, and the holographic image and the reflection image display contents of supplementary scenes. For another example, the holographic image provided by the holographic image display device includes a holographic image of a basketball or the like that moves up and down, accordingly, the display image provided by the reflection image display device includes a robot, and the robot's hand moving up and down. Taking the observation from the side where the holographic image display device is located for an example, the naked-eye three-dimensional image finally provided for the observer is a combination of the reflection image and the holographic image, and the combined image gives the observers the feeling that the robot beats the basketball by hand and moves the basketball up and down. The naked-eye three-dimensional image formed under this condition gives the observer a more three-dimensional visual experience.

For example, the display contents of the holographic image display device and the reflection image display device may be controlled independently, in this way, the display contents displayed by the holographic image display device and the reflection image display device can be freely adjusted respectively to form a display image conforming to the observer's requirements. For example, in a case that the images that a person performs under different weather conditions are displayed, the images under different weather conditions are displayed by the reflection image display device, the contents that a person performs is displayed by the holographic image display device. By controlling the holographic image display device and the reflection image display device separately, different weather conditions and different performance contents can be selected.

For example, the holographic image is displayed as a foreground or a background of the reflection image; or the reflection image is displayed as a foreground or a background of the holographic image. For example, the holographic image is displayed as a three-dimensional image, the reflection image is displayed as a two-dimensional image, and the reflection image is displayed as a background of the holographic image.

The display system and the display method of the display system provided by the embodiment of the present disclosure have at least one of the following beneficial effects: the holographic image display device and the reflection image display device arranged in parallel and included in the display system display the holographic image and the reflection image respectively to achieve a stereoscopic display; the stereoscopic display image can be observed by a plurality of people at a same time and observed by naked-eyes, and further can be observed at multiple angles without any visual equipments, and gives a real stereoscopic experience for the observers.

The following points need to be explained:

(1) The drawings of the embodiments of the present disclosure are only related to the structures related to the embodiments of the present disclosure, and other structures can refer to general designs.

(2) For clarity, in the drawings for describing the embodiments of the present disclosure, a thickness of a layer or a thickness of a region is exaggerated or reduced, that is, these drawings are not drawn according to an actual scale. It should be understood that: in a case that an element such as a layer, a film, a region or a substrate is referred to as being disposed “on” or “beneath” another element, the element may be “directly” disposed “on” or “beneath” another element, or an intermediate element may be provided.

(3) In the absence of conflict, the embodiments of the present disclosure and the features in the embodiments can be combined with each other to obtain new embodiments.

What is described above is related to the illustrative embodiments of the disclosure only and not limitative to the scope of the disclosure. Therefore, the scopes of the disclosure are defined by the accompanying claims.

1. A display system, comprising:
at least one holographic image display device, each holographic image display device is configured to display a holographic image of a scene;
at least one reflection image display device, each reflection image display device is configured to display a reflection image of a scene; wherein the at least one holographic image display device and the at least one reflection image display device are arranged in parallel, and the holographic image and the reflection image are displayed to achieve a stereoscopic display in a display side of the display system.

2. The display system according to claim 1, wherein the stereoscopic display is a multi-layer stereoscopic display.

3. The display system according to claim 1, wherein the holographic image display device and the reflection image display device are arranged side by side in a horizontal direction or arranged side by side in a vertical direction.

4. The display system according to claim 1, wherein the holographic image display device comprises a holographic film and a first projector.

5. The display system according to claim 4, wherein the holographic film comprises a mirror layer, a first filter layer, a matrix layer, a second filter layer and a bead layer which are stacked in sequence.

6. The display system according to claim 5, wherein the first filter layer is a carbon black layer, and the second filter layer is a transparent filter layer.

7. The display system according to claim 1, wherein the reflection image display device comprises a reflective component and a display component.

8. The display system according to claim 7, wherein the display component is a second projector.

9. The display system according to claim 7, wherein the reflective component comprises a transflective component or a total reflective component.

10. The display system according to claim 9, wherein the transflective component comprises a substrate and a coating applied to a main surface of the substrate.

11. The display system according to claim 10, wherein the main surface of the substrate is entirely or partially coated with the coating.

12. The display system according to claim 11, wherein the coating is made of polyethylene terephthalate or an opaque metal material.

13. The display system according to claim 9, wherein the transflective component is provided with light-transmitting holes arranged at intervals or light-transmitting slits arranged at intervals.

14. A display method of the display system according to claim 1, comprising:
the holographic image display device displays a holographic image and the reflection image display device displays a reflection image to achieve a stereoscopic display.

15. The display method according to claim 14, further comprising:
the holographic image and the reflection image display a content of a same scene; or
the holographic image and the reflection image display contents of supplementary scenes.

16. The display method according to claim 15, further comprising:
the holographic image is displayed as a foreground or a background of the reflection image; or
the reflection image is displayed as a foreground or a background of the holographic image.

17. The display system according to claim 2, wherein the holographic image display device and the reflection image display device are arranged side by side in a horizontal direction or arranged side by side in a vertical direction.

18. The display system according to claim 2, wherein the holographic image display device comprises a holographic film and a first projector.

19. The display system according to claim 3, wherein the holographic image display device comprises a holographic film and a first projector.

20. The display system according to claim 10, wherein the transflective component is provided with light-transmitting holes arranged at intervals or light-transmitting slits arranged at intervals.
